(19) United States
(12) Patent Application Publication
(10) Pub. No.: US 2007/0009173 A1
(43) Pub. Date: Jan. 11, 2007

(54) Apparatus and method for shading correction and recording medium therefore

(75) Inventor: Akihiro Wakabayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/356,224

(22) Filed: Feb. 17, 2006

(30) Foreign Application Priority Data
Jun. 28, 2005 (JP) 2005-187512

(51) Int. Cl. G06K 9/40

(52) U.S. Cl. 382/274

(57) ABSTRACT

A shading correction apparatus, method, and program capable of realizing high-speed and high-quality correction include: a work as an object to be captured; a capture unit for capturing the work; a background image data generation unit for generating background image data from original image data generated by the capture unit; and a correcting process unit correcting uneven luminance of the original image data using the background image data.

### BACKGROUND OF THE INVENTION

1. Field of the Invention

The present invention relates to a shading correction apparatus and method capable of correcting the uneven luminance of an image obtained by capturing an object, and a program for them.

2. Description of the Related Art

To manage the quality of a product, etc. manufactured on a production line in a factory, etc., for example, checking the presence/absence of a defect of a product by capturing the appearance of a product using a camera, etc. and analyzing image data is commonly performed in a producing step.

However, in many cases an image captured by a camera, etc. is accompanied by uneven luminance from the center to circumference of the image depending on the uneven illumination and the characteristic of a lens. Accordingly, when the image data is analyzed, erroneous detection or determination frequently occurs. Therefore, the uneven luminance caused on image data is normally corrected (hereinafter referred to as “shading correction”).

A method of shading correction can be commonly realized by preparing a background image obtained by extracting only uneven luminance information from image data, and dividing the image data by the background image and normalizing the result, thereby removing the uneven luminance component.

The background image can be generated in advance, or generated from an original image when a correcting process is performed.

When it is generated in advance, for example, image data obtained by taking a flat portion of the material the same as or similar to the object to be captured, or image data obtained by processing image data obtained by capturing the object to be captured is used as a background image. However, since there are variations in surface of a product manufactured on a production line, there are also variations in uneven luminance, and desired shading correction can be hardly performed. As a result, shading correction is generally performed by generating a background image from an original image when a correcting process is made.

When a background image is generated from each original image such as a product, etc. as an object to be captured, a digital filter process is performed using a low pass filter, etc. on an original image. Thus, a background image is generated.

However, the larger the original image treated in the digital filter process requiring more arithmetic operations, the longer the time required to generate a background image.

To solve the above-mentioned problem, Japanese Published Patent Application No. Hei 09-005057 discloses a shading correcting method using image data of 320×256×14 bit levels of gray as a background image obtained by compressing the image data captured with a CCD camera.

Japanese Published Patent Application No. 2003-153132 discloses a shading correction circuit for performing shading correction by generating a background image by reducing/enlarging image data from a camera.

FIG. 1 shows original image data obtained by capturing the appearance of the top surface of the housing of a notebook PC by a CCD camera. FIG. 2 shows background image data obtained by generating background image data by performing a reducing/enlarging process on the original image data.

The white line shown in FIG. 2 indicates a boundary line b of the housing of a notebook PC captured and represented by the original image data shown in FIG. 1.

Around the boundary line b shown in FIG. 2, the gradation (gray scale) is generated from inside to outside (or from outside to inside) of the boundary line b. That is, in the background image data, the luminance inside the boundary line b is lower than the practical luminance. Accordingly, when shading correction is performed on the original image data using the background image data, the luminance inside the boundary line b is excessively corrected.

Since the luminance value at the outside of the boundary line b is higher than the practical value, the luminance is excessively corrected when the shading correction is performed. However, it is not a serious problem because the portion is the background area.

FIG. 3 shows corrected image data obtained by performing shading correction using the background image data shown in FIG. 2. The housing of the notebook PC is excessively corrected in white around the boundary of the background image. For example, as compared with a shown in FIG. 1, c shown in FIG. 3 is excessively corrected in white around the boundary between the housing of the notebook PC and the background.

As described above, the background image generating process can be quickly performed, but the excess correction around the dark and bright boundary, etc. of the original image causes excess uneven luminance.

### SUMMARY OF THE INVENTION

The present invention has been developed to solve the above-mentioned problems, and aims at providing a shading correction apparatus, method, and program capable of performing high-speed and high-quality correction.

To attain the above-mentioned objective, the shading correction apparatus according to the present invention includes a capture unit for generating image data by capturing an object, a background image data generation unit for generating background image data by smoothing the gray scale of the image data and shifting the boundary area between the object and the background generated in the image data, and a correcting process unit for performing a shading correcting process on the image data using the background image data.

According to the present invention, after the background image data generation unit smoothes the gray scale of the image data captured by the capture unit, it shifts the boundary area between the object and the background outside the contour of the object captured in the image data, thereby possibly preventing the excess correction by the shading correction due to the gray-scale boundary area.

As described above, according to the present invention, a shading correction apparatus, method, and program capable of performing high-speed and high-quality correction can be provided.

### BRIEF DESCRIPTION OF THE DRAWINGS

FIG. 1 shows original image data obtained by capturing the appearance of the upper surface of the housing of the notebook PC using a CCD camera;

FIG. 2 shows background image data generated by the conventional technology of generating background image data by performing only a reducing/enlarging process on the original image data;

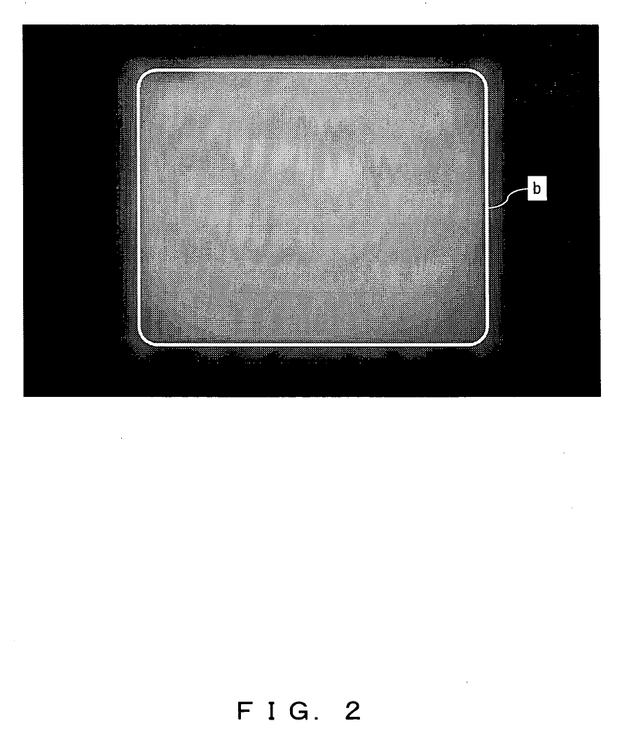

FIG. 3 shows corrected image data obtained by performing shading correction using the background image data shown in FIG. 2;

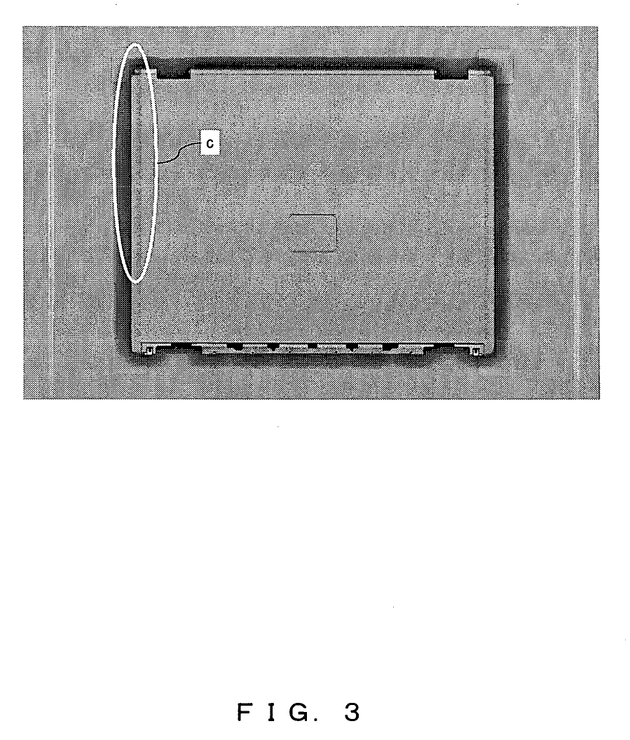

FIG. 4 shows the principle of the shading correction apparatus according to the present invention;

FIG. 5 shows an example of the configuration of the checking system using the shading correction apparatus according to the present invention;

FIG. 6 is a block diagram of the checking system realized by the image processing device shown in FIG. 5;

FIG. 7 is a flowchart of the important process of the checking system using the shading correction apparatus according to an embodiment of the present invention;

FIG. 8 shows the concept of the down sampling method according to an embodiment of the present invention;

FIG. 9 shows the concept of the average operation method according to an embodiment of the present invention;

FIG. 10 is a flowchart of the maximum filter process according to an embodiment of the present invention;

FIG. 11 shows the concept of the maximum filter arithmetic according to an embodiment of the present invention;

FIG. 12 shows the concept of the linear interpolation method;

FIG. 13 shows the concept of the linear interpolation method;

FIG. 14 shows the background image data generated by the shading correction apparatus according to an embodiment of the present invention; and

FIG. 15 shows the corrected image data obtained by performing shading correction using the background image data shown in FIG. 14.

### DESCRIPTION OF THE PREFERRED EMBODIMENTS

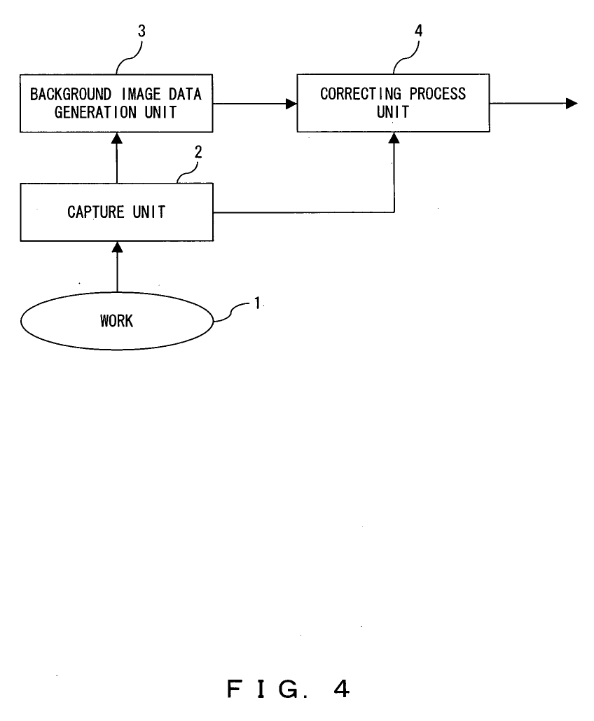

The embodiments of the present invention are explained below by referring to FIGS. 4 through 15.

FIG. 4 shows the principle of the shading correction apparatus according to the present invention.

The shading correction apparatus shown in FIG. 4 comprises a capture unit 2 for capturing a work 1 as an object to be captured, a background image data generation unit 3 for generating background image data from the image data generated by the capture unit 2 (hereinafter referred to as “original image data”), and a correcting process unit 4 for correcting the uneven luminance of the original image data using the background image data.

The work 1 is, for example, a product manufactured on a production line in a factory, etc., and the presence/absence of a defect can be determined by analyzing the image data obtained by capturing the product.

The capture unit 2 captures the work 1, and can be, for example, a CCD camera for generating original image data of the work 1 using an image pickup element such as a CCD (charge coupled device), etc.

The background image data generation unit 3 generates background image data by smoothing the gray scale of the original image data generated by the capture unit 2, and shifting the gradation generated in the boundary area between the work 1 and the background.

The boundary area between the work 1 and the background is a gradation area generated over the boundary line between the work 1 and the background, and is an area having a luminance value indicating excess correction when shading correction is performed using the luminance value of the area.

To smooth the gray scale of original image data, the original image data is reduced to a predetermined size using the down sampling method, the average operation method, etc. (the original image data is hereinafter referred to as “first reduced image data”).

Furthermore, the background image data generation unit 3 shifts the gradation generated in the boundary area between the work 1 and the background (the image data is hereinafter referred to as “second reduced image data”) such that the pale color portion of the first reduced image data can be expanded (or reduced).

Then background image data is generated by expanding the second reduced image data to the size of the original image data in the linear interpolation method, etc.

The correcting process unit 4 divides original image data by background image data and normalizes the result, thereby performing a correcting process of removing the uneven luminance component of the original image data. Otherwise, the uneven luminance component can be removed by subtracting the background image data from the original image data.

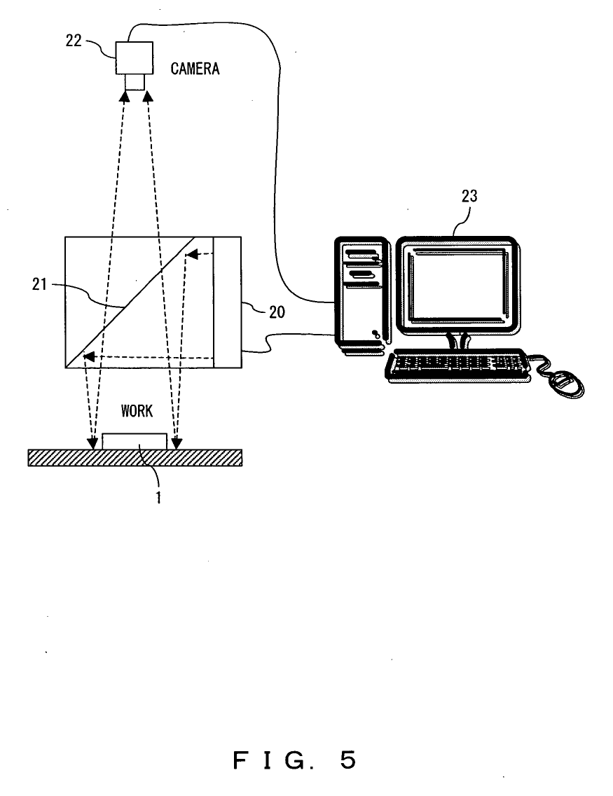

FIG. 5 shows an example of the configuration of the checking system using the shading correction apparatus according to the present invention.

The checking system shown in FIG. 5 comprises at least an illumination device 20 for illuminating the work 1, a half mirror 21 for reflecting the light from the illumination device 20 and illuminating the work 1, and transmitting the light reflected by the work 1, a camera 22 for receiving the light transmitted through the half mirror 21, capturing the work 1, and generating original image data, and an image processing device 23 for generating image data for analysis of an image by performing shading correction on the original image data, and making a check by analyzing the image data.

In the explanation above, the capture unit 2 is realized by the camera 22. The background image data generation unit 3 and the correcting process unit 4 are realized by the image processing device 23.

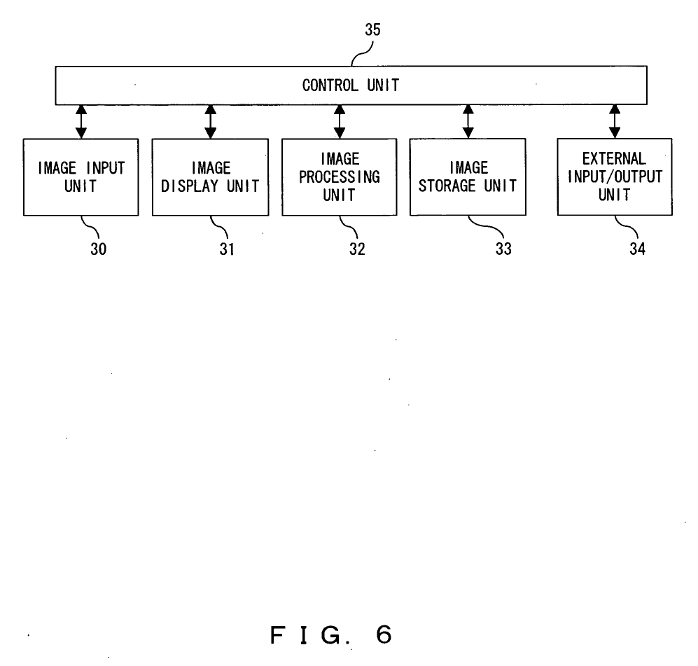

FIG. 6 is a block diagram showing the function of the image processing device 23 according to an embodiment of the present invention.

The image processing device 23 shown in FIG. 6 comprises at least an image input unit 30 for receiving original image data from the camera 22, an image display unit 31 for display image data, etc., an image processing unit 32 for performing image processing such as generating a background image from the original image data, an image storage unit 33 for storing image data, etc. an external input/output unit 34 as an interface with an external device, and a control unit 35 for controlling the entire image processing device 23.

The image input unit 30 is an interface connected to the camera 22, and receives original image data of the work 1 captured by the camera 22. The image display unit 31 is, for example, a CRT, an LCD, etc., and displays image data, etc. at an instruction of the control unit 35.

The image processing unit 32 generates background image data by performing image processing on the original image data input to the image input unit 30, and performs shading correction on the original image data using the background image data.

The image processing unit 32 analyzes the original image data treated by shading correction, thereby checking the quality by confirming whether or not there is a defect in the work 1 corresponding to the original image data.

The image storage unit 33 stores original image data obtained by the camera 22, background image data generated by the image processing unit 32, original image data after performing shading correction, etc., at an instruction of the control unit 35.

The image storage unit 33 can be, for example, volatile memory (for example, RAM), non-volatile memory (for example, ROM, EEPROM, etc.), a magnetic storage device, etc.

The external input/output unit 34 is provided with, for example, an input unit such as a keyboard, a mouse, etc., and an output device of a network connection device, etc.

The image processing unit 32 and the control unit 35 explained above can be realized by the CPU, which is not shown in the attached drawings but is provided for the image processing device 23, reading a program stored in the storage device, which is not shown in the attached drawings but is provided for the image processing device 23, and executing an instruction described in the program.

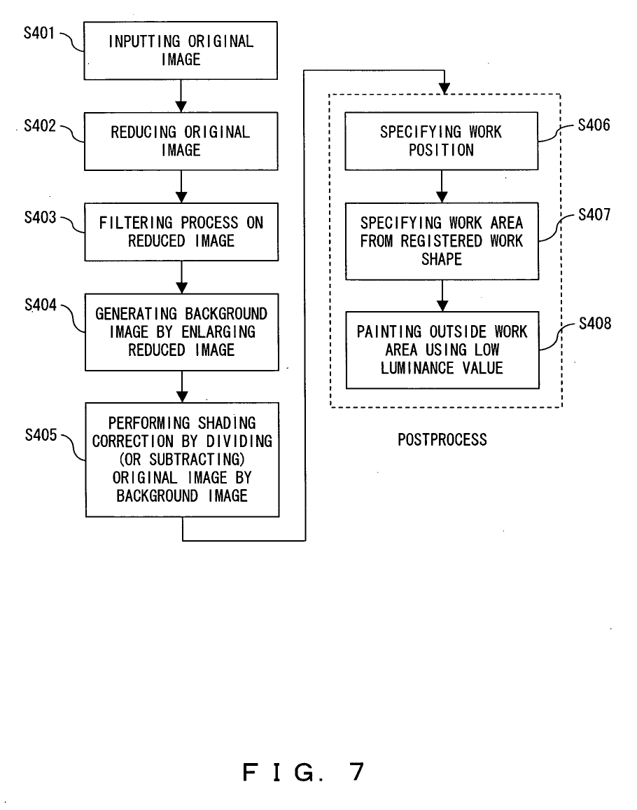

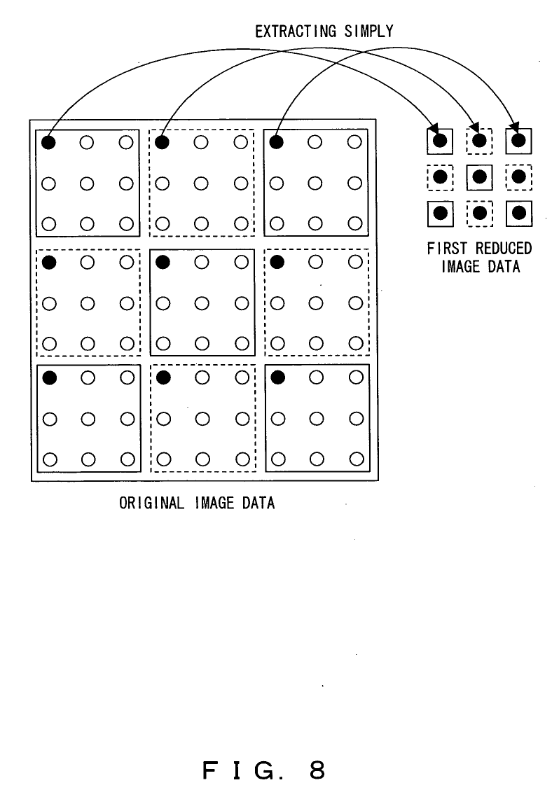

The process of the checking system according to an embodiment of the present invention is explained below by referring to the flowchart shown in FIG. 7, and FIGS. 8 through 13.

FIG. 7 is a flowchart of the important process of the checking system using the shading correction apparatus according to an embodiment of the present invention.

Instep S401, the control unit 35 captures the work 1 using the camera 22, and generates original image data. The generated original image data is stored in the image storage unit 33 through the image input unit 30, and control is passed to step S402.

In step S402, the image processing unit 32 reads the original image data stored in the image storage unit 33, reduces it to a predetermined size, and generates reduced image data (hereinafter referred to as “first reduced image data”).

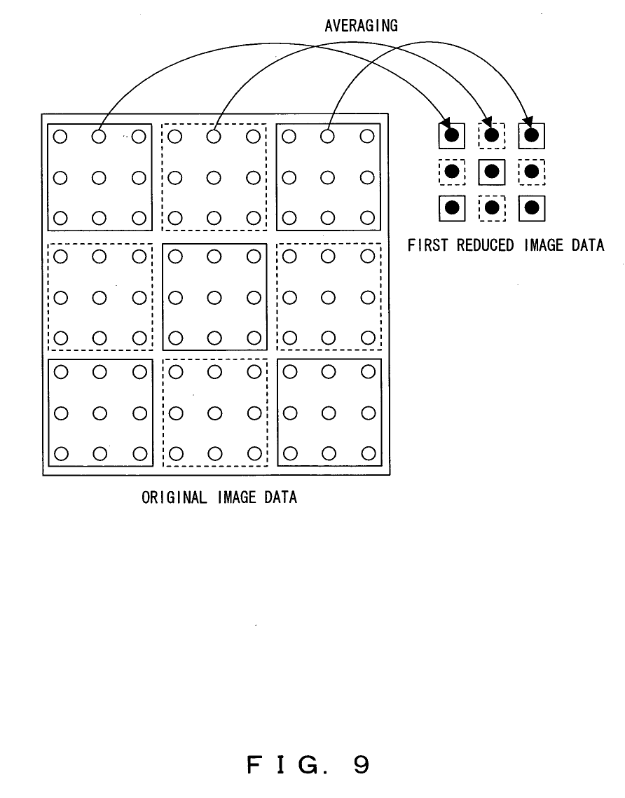

Then, to generate the first reduced image data from the original image data, the down sampling method and the average operation method can be used. The down sampling method and the average operation method are explained later by referring to FIGS. 8 and 9.

In step S402, when the first reduced image data is completely generated, the image processing unit 32 passes control to step S403. Then, the expanding process (or reducing process) is performed on the first reduced image data, and the boundary area between the work 1 and the background expressed by the first reduced image data is shifted to generate the second reduced image data.

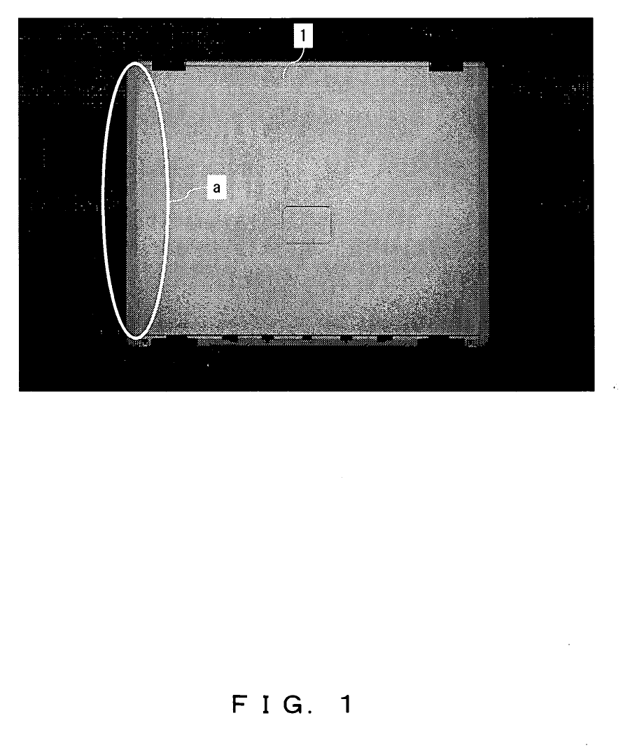

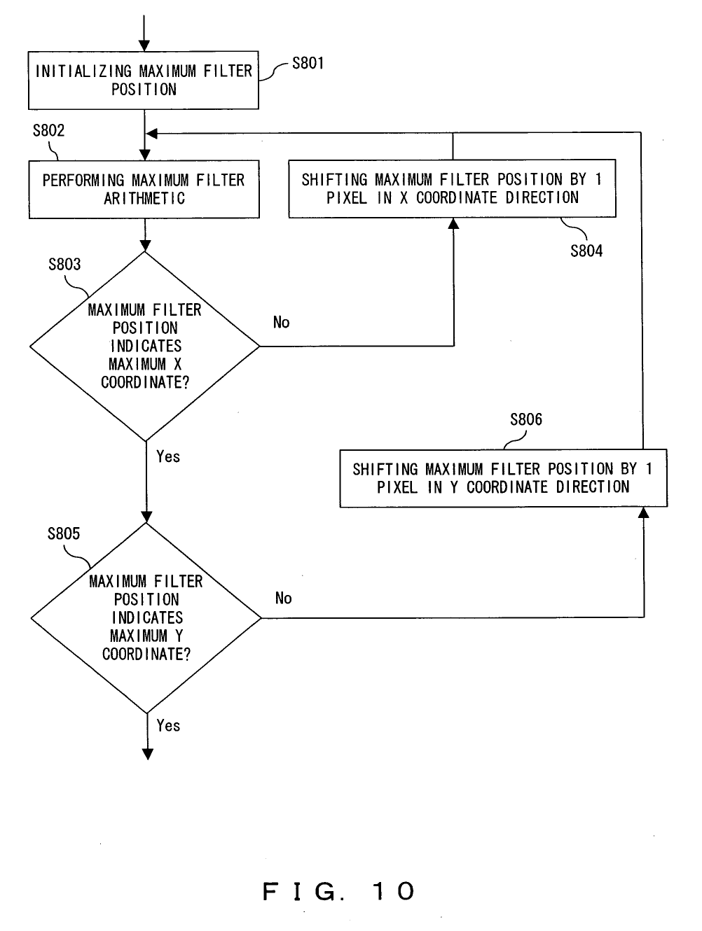

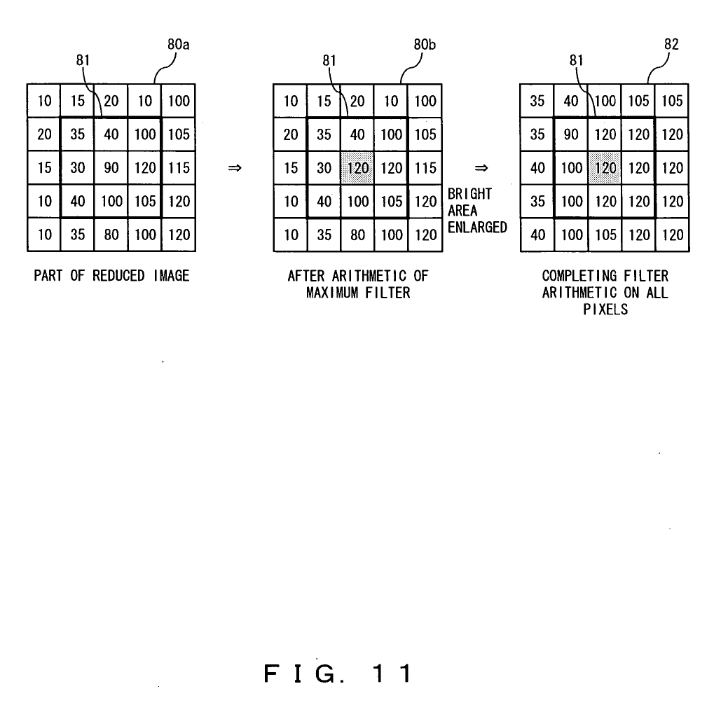

To generate the second reduced image data from the first reduced image data, a maximum filter process or a minimum filter process is performed on the first reduced image data. For example, as shown in FIG. 1, when the background is lower in luminance than the work 1, the maximum filter process (expanding process) is performed. When the background is higher in luminance than the work 1, the minimum filter process (reducing process) is to be performed. Since the maximum filter process and the minimum filter process are based on the same principle, only the maximum filter process is explained below by referring to FIGS. 10 and 11.

In step S403, when the second reduced image data is completely generated, the image processing unit 32 passes control to step S404, and enlarges the second reduced image data to the size of the original image data, thereby generating background image data.

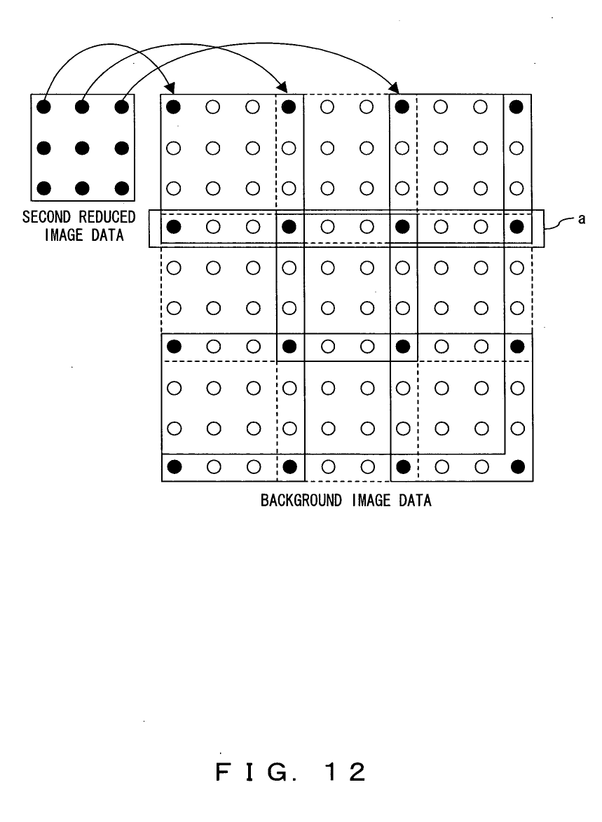

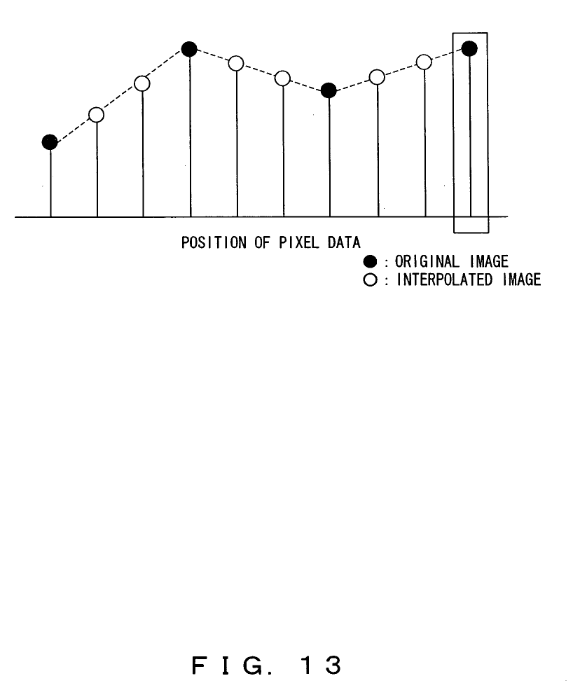

To generate the background image data by enlarging the second reduced image data, the linear interpolation method is used in the present embodiment. The linear interpolation method is explained later by referring to FIGS. 12 and 13.

Instep S404, when the background image data is completely generated, the image processing unit 32 passes control to step S405. Then, the luminance value of the original image data is divided by the luminance value of the background image data, thereby performing the shading correcting process of removing the uneven luminance component of the original image data.

In the present embodiment, the luminance value of the original image data is divided by the luminance value of the background image data, thereby removing the uneven luminance component of the original image data. It is also possible to remove the uneven luminance component of the original image data by performing a subtraction on the luminance value of the original image data and the luminance value of the background image data.

When shading correction is completed on the original image data in the processes in steps S402 through S405, the image processing unit 32 passes control to step S406, and the image processing of checking the presence/absence of a defect is performed on image data treated by the shading correction (hereinafter referred to as “corrected image data”).

In step S406, the image processing unit 32 specifies the position of the work 1 captured in the corrected image data by comparing the image data of a prepared work (hereinafter referred to as a “reference work”) with the corrected image data.

For example, plural pieces of image data clearly indicating the difference in gray scale in the image data of the reference work (hereinafter referred to as “image data for comparison”) are prepared, and each piece of image data for comparison is compared with the corrected image data.

Then, based on the position of the image data for comparison to be matched with the corrected image data and the shape of the reference work, the position of the work 1 captured in the corrected image data can be specified.

In step S406, when the position of the work 1 captured in the corrected image data is specified, the image processing unit 32 passes control to step S407. Then, the shape of the reference work is read, and the range of the image of the work 1 captured in the corrected image data (hereinafter referred to as a “work area”) is specified based on the shape of the reference work and the position of the work 1 specified in step S406.

In step S407, when a word area is specified, the image processing unit 32 passes control to step S408, converts the luminance value of the portion other than the word area in the corrected image data to a low luminance value (for example, the luminance value of 0), and generates image data for use in a check.

Afterwards, the image processing device 23 analyzes an image using the image data generated in step S408, thereby checking the presence/absence of a defect.

The down sampling method and the average operation method are explained below by referring to FIGS. 8 and 9. FIG. 8 shows the concept of the down sampling method, and FIG. 9 shows the concept of the average operation method.

The original image data shown in FIG. 8 is the data of a 9 by 9 matrix of pixels. Each of the black and white points indicates a piece of pixel data, and the black point indicates extracted pixel data.

In the down sampling method, the original image data is divided into predetermined areas (3×3 pixels in FIG. 8), only the image data in the predetermined positions (upper left divided areas in FIG. 8) of the divided areas are extracted to generate the first reduced image data of 3×3 pixels.

The original image data shown in FIG. 9 also indicates the image data of a 9 by 9 matrix of pixels. Each of the black and white points indicates a piece of image data, and the black point indicates extracted pixel data.

In the average operation method, the original image data is divided into predetermined areas (3×3 pixels in FIG. 9), and the average value of the luminance values (or RGB values) of the pixel data of the respective divided areas is calculated. Then, the calculated pixel data is extracted and the first reduced image data of 3 by 3 matrix of pixels is generated.

In the above-mentioned method, the image data of one ninth ( 1/9) size of the original image data (first reduced image data) is generated. Since the above-mentioned down sampling method and the average operation method is a commonly known technology, the detailed explanation is omitted here.

In FIGS. 8 and 9, the size of a divided area obtained from the original image data is 3×3 pixels, but the size of the area for use in the down sampling method or the average operation method according to the present embodiment is not limited to 3×3 pixels.

The maximum filter process is explained below by referring to FIGS. 10 and 11.

FIG. 10 is a flowchart of the maximum filter process. The maximum filter process shown in FIG. 10 is explained using the size of a maximum filter of a 3 by 3 matrix of pixels, but the size of a maximum filter is not limited to this case.

Assuming that the area of a maximum filter is based on an optional XY coordinates (X0, Y0), the area can be expressed by “(X0, Y0)−(X0+3, Y0) and (X0, Y0)−(X0, Y0+3)”. In the following explanation, the coordinates (X0, Y0) is referred to as a “maximum filter position”.

In FIG. 7, when control is passed to step S403, the image processing unit 32 initializes the maximum filter position to the XY coordinates (0, 0) in the first reduced image data (step S801).

When the maximum filter position is initialized, the image processing unit 32 transfers control to step S802, and performs a maximum filter arithmetic. The maximum filter arithmetic is explained by referring to FIG. 11.

When the maximum filter arithmetic is completed, the image processing unit 32 passes control to step S803, and checks whether or not the X coordinate of the maximum filter position indicates the maximum value.

When the X coordinate of the maximum filter position does not indicate the maximum value, control is passed to step S804. Then, the image processing unit 32 shifts (increments) the maximum filter position in the X coordinate direction by one pixel, and passes control to step S802. Then, the processes in steps S802 through S804 are repeated until the X coordinate of the maximum filter position reaches the maximum value.

When the X coordinate of the maximum filter position indicates the maximum value, control is passed to step S805. Then, it is checked whether or not the Y coordinate of the maximum filter position indicates the maximum value.

When the Y coordinate of the maximum filter position does not indicate the maximum value, control is passed to step S806. Then, the image processing unit 32 shifts (increments) the maximum filter position in the Y coordinate direction by one pixel, and passes control to step S802. Then, the processes in steps S802 through S806 are repeated until the Y coordinate of the maximum filter position reaches the maximum value.

When the Y coordinate of the maximum filter position indicates the maximum value, it is determined that the maximum filter arithmetic has been completed, and control is passed to step S404 shown in FIG. 7.

FIG. 11 shows the concept of the maximum filter arithmetic. FIG. 11 shows first reduced image data 80a and 80b, a maximum filter 81, and a second reduced image data 82. The values in the frames of the first reduced image data 80a and 80b, and the second reduced image data 82 indicate the luminance values of the respective pixels.

Assuming that the maximum filter 81 is set as the first reduced image data 80a, the image processing unit 32 detects the maximum luminance value of 120 from the maximum filter 81.

When the maximum luminance value is detected, the image processing unit 32 replaces the value of the central pixel of the maximum filter 81 with the maximum luminance value of 120, and generates the first reduced image data 80b.

The maximum filter position is sequentially shifted and the similar process is performed on the entire area of the first reduced image data 80a, thereby obtaining the second reduced image data 82.

The second reduced image data 82 indicates the enlarged (expanded) area having a high luminance value (for example, the area having the luminance value of 120).

Described above is the maximum filter process, and the minimum filter process is based on the same principle. For example, the minimum luminance value of 30 is detected from the maximum filter 81, and the value of the central pixel is replaced with the minimum luminance value of 30 to generate the first reduced image data 80b.

The linear interpolation method is explained below by referring to FIGS. 12 and 13. FIGS. 12 and 13 show the concept of the linear interpolation method.

The second reduced image data shown in FIG. 12 is image data of a 3 by 3 matrix of pixels, and the background image data is image data of a 9 by 9 matrix of pixels. Each of the black and white points indicates a piece of image data, and a white point indicates the pixel data interpolated by the image processing unit 32 in the linear interpolation method.

In the linear interpolation method, the interval of the arrangement of each piece of pixel data of the second reduced image data is enlarged to a predetermined interval (three times in the present embodiment), and the pixel data is interpolated such that the luminance value between the pixel data can be smoothly changed.

FIG. 13 shows the relationship between the position of the pixel data of the data row a of a part of the background image data shown in FIG. 12 and the luminance value.

As explained above by referring to FIG. 12, in the linear interpolation method, the pixel data is interpolated at equal intervals by connecting pixel data of the second reduced image data using straight lines such that each piece of pixel data after interpolation can be smoothly changed and arranged on the straight lines.

In the method explained above, the image data (background image data) that is nine times the second reduced image data is generated. Since the above-mentioned linear interpolation method is a commonly known technology, the detailed explanation is omitted here.

In the linear interpolation method according to the present embodiment, the arrangement interval of each piece of pixel data of the second reduced image data is three times enlarged. However, it is not limited to this factor, but any factor can be used as necessary.

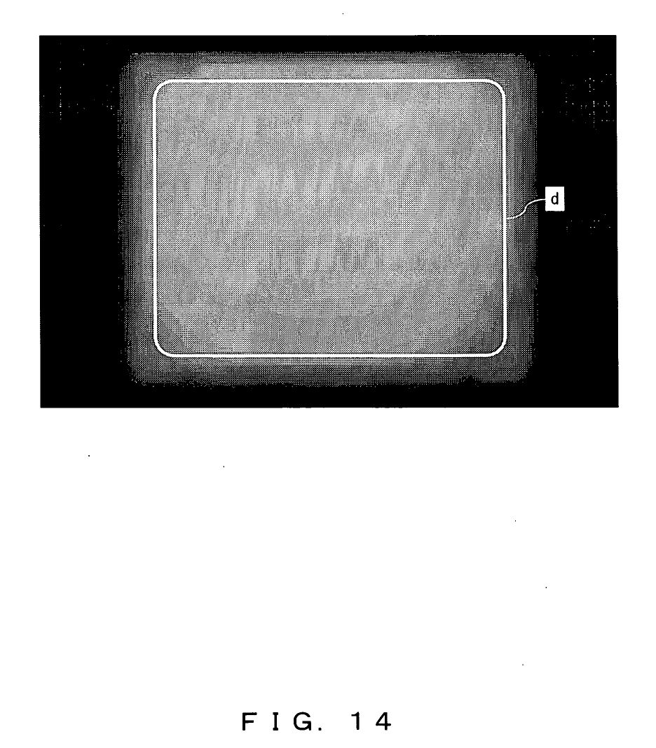

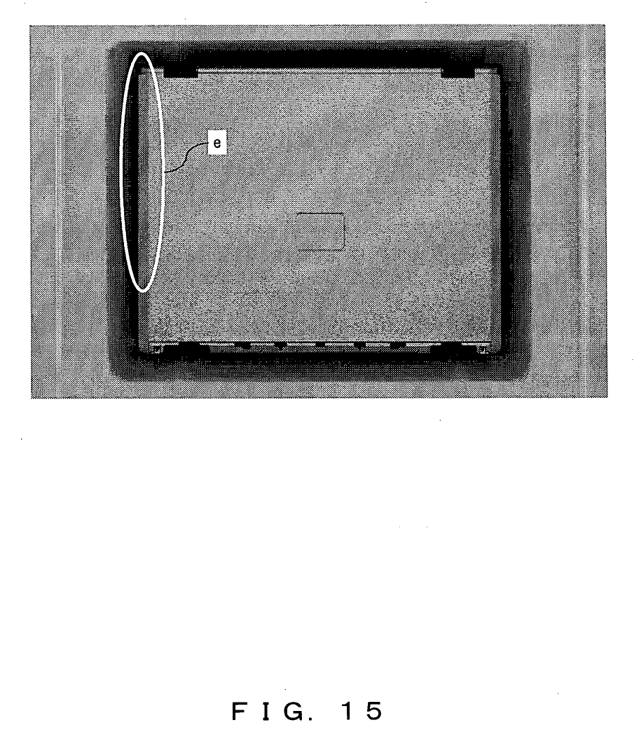

FIGS. 14 and 15 show the effect of the shading correction apparatus according to the present embodiment.

FIG. 14 shows the background image data generated by the shading correction apparatus according to the present embodiment. The white line shown in FIG. 14 indicates the boundary line d of the housing of the notebook PC captured in the original image data shown in FIG. 1.

The background image data shown in FIG. 14 is treated in the maximum filter process (expanding process) shown in FIGS. 10 and 11. As a result, the gradation is generated outside the boundary line d. That is, the boundary area is shifted to the outside of the boundary lined. Therefore, the luminance inside the boundary line d is not excessively corrected although the shading correction is performed on the original image data using the background image data.

FIG. 15 shows the corrected image data obtained by performing the shading correction using the background image data shown in FIG. 14. The housing of the notebook PC is not excessively corrected around the boundary of the background image. For example, in the comparison between a shown in FIG. 1 and e shown in FIG. 15, the boundary between the housing of the notebook PC and the and the background is not excessively corrected in white, but the correction is made only to uneven luminance.

As explained above, the shading correction apparatus according to the present embodiment can prevent excess correction to uneven luminance from being performed by the shading correction, thereby realizing high quality correction.

The shading correction apparatus according to the present embodiment performs a maximum filter process on the reduced original image data, thereby performing a high-speed filtering process. As a result, the background image data can be quickly generated. Accordingly, a high-speed and high-quality shading correction process can be performed.

What is claimed is:

1. A shading correction apparatus, comprising:
a capture unit generating image data by capturing an object;
a background image data generation unit generating background image data by smoothing gray scale of the image data and shifting a boundary area between the object and a background generated in the image data; and
a correcting process unit performing a shading correcting process on the image data using the background image data.

2. The apparatus according to claim 1, wherein
the background image data generation unit comprises:
a reducing process unit generating first reduced image data by reducing the image data;
a filtering process unit generating second reduced image data by performing an expanding process on the first reduced image data, and shifting the boundary area; and
an enlarging process unit generating the background image data by enlarging the second reduced image data to the image data.

3. The apparatus according to claim 2, wherein
the expanding process is a maximum filter process of performing on all areas of the image data a process of detecting a maximum value of a luminance value of an area drawn by a maximum filter which draws a predetermined area on the image data, and replacing the detected maximum value with a luminance value of a predetermined maximum filter position.

4. A shading correcting method used to allow an image processing device to perform:
a capturing process of generating image data by capturing an object;
a background image data generating process of generating background image data by smoothing gray scale of the image data and shifting a boundary area between the object and a background generated in the image data; and
a correcting process of performing a shading correcting process on the image data using the background image data.

5. The method according to claim 4, wherein
the background image data generating process comprises:
a reducing process of generating first reduced image data by reducing the image data;
a filtering process of generating second reduced image data by performing an expanding process on the first reduced image data, and shifting the boundary area; and
an enlarging process unit of generating the background image data by enlarging the second reduced image data to the image data.

6. The method according to claim 5, wherein
the expanding process is a maximum filter process of performing on all areas of the image data a process of detecting a maximum value of a luminance value of an area drawn by a maximum filter which draws a predetermined area on the image data, and replacing the detected maximum value with a luminance value of a predetermined maximum filter position.

7. A recording medium storing a program for shading correction used to allow an image processing device, comprising:
a capturing process of generating image data by capturing an object;
a background image data generating process of generating background image data by smoothing gray scale of the image data and shifting a boundary area between the object and a background generated in the image data; and
a correcting process of performing a shading correcting process on the image data using the background image data.

8. The recording medium storing a program for shading correction used to allow an image processing device according to claim 7, wherein
the background image data generating process comprises:
a reducing process of generating first reduced image data by reducing the image data;
a filtering process of generating second reduced image data by performing an expanding process on the first reduced image data, and shifting the boundary area; and
an enlarging process unit of generating the background image data by enlarging the second reduced image data to the image data.

9. The recording medium storing a program for shading correction according to claim 8, wherein
the expanding process is a maximum filter process of performing on all areas of the image data a process of detecting a maximum value of a luminance value of an area drawn by a maximum filter which draws a predetermined area on the image data, and replacing the detected maximum value with a luminance value of a predetermined maximum filter position.
